(19) United States
(12) Patent Application Publication
(10) Pub. No.: US 2007/0066169 A1
(43) Pub. Date: Mar. 22, 2007

(54) Material for making outer wrapping material by laminating a web material with a base material

(76) Inventors: Jorge Perelman, Del. V. Carranza (MX); Patrick J. Tighe, New York, NY (US); Rosa Maria Diaz Bautista, San Cristobal Ecatepec (MX); Gabriel Pujol, Bayside, WI (US); Pedro Gude Carbonell, Del. B. Juarez (MX); Haroldo Barrios Puga, Satelite (MX)

Correspondence Address: LAU & ASSOCIATES, LLC;MICHAEL N. LAU, 2121 EISENHOWER AVENUE, SUITE 503A, ALEXANDRIA, VA, 22314, US

(21) Appl. No.: 11/580,156

(22) Filed: Oct. 13, 2006

Related U.S. Application Data
(62) Division of application No. 11/126,282, filed on May 11, 2005.

(51) Int. Cl. B32B 27/04; B32B 5/02

(52) U.S. Cl. 442/149

(57) ABSTRACT

An apparatus for producing a durable and high strength laminated material. In this apparatus, a layer of base material and a layer of web material are laminated and bound with a water-based adhesive to form a new material. During lamination, both base and web materials are concurrently fed into a pair of rollers to effect cold lamination to yield a continuous laminated sheeting. The laminated sheeting emerged from the combining rollers is capable of being cut, sewn or glued and can be used as raw material to produce durable and reusable laminated boxes, gift bags, gift wraps, scrapbooks, covers, shower curtains, etc.

### FIELD OF THE INVENTION

The present invention is related generally to a laminated sheeting, and more particularly related to manufacturing a new material by laminating two separate materials. More specifically, this invention relates to creating a new material by crimping and adhering a web material with a base material. The process of making the new material gives a firm strength to both materials, and maintaining the integrity and natural characteristics of color and finish of both materials. The new material that is created with this new process is, for example, a continuous material formed from at least bi-axially oriented material, paper or any plastic material such as polypropylene, polyester, nylon or any elastomer product.

### DESCRIPTION OF THE RELATED ART

Conventional foldable bags have been in the marketplace for many years. They are typically shaped as shown in various figures of U.S. Pat. No. 6,000,849 issued to Keller; U.S. Pat. No. 6,146,618 issued to Keller; U.S. Pat. No. 6,345,912 issued to Ho; U.S. Pat. No. 6,737,959 issued to Ho; U.S. Pat. No. 6,749,064 issued to Alrey; U.S. Pat. No. 5,836,095 issued to Crowell; U.S. Pat. No. 6,045,263 issued to Keller; U.S. Pat. No. 5,613,312 issued to Crowell; U.S. Pat. No. 6,045,263 issued to Keller; U.S. Pat. No. 5,613,312 issued to Crowell; and U.S. Pat. No. 5,441,348 issued to Valentino. These foldable bags are generally made of paper or plastic.

While thick paper sheets are able to withstand acceptable amount of load and stress, the material strength of paper deteriorates substantially when used repeatedly, when it becomes wet, or when it is punctured. As individual fibers making up a paper sheet becomes wet, they tend to absorb the water in their surrounding until the amount of absorption reaches a saturation point. Moisturized or soaked fibers swell up and expand in size. Due to this fiber expansion, the frictional force holding numerous fibers together would become weaken as contact surfaces of the fibers decreased. In addition, each of the individual swelled fibers also disintegrates and allows the paper sheet to become more susceptible to tears. Consequently, the durability of a bag made of paper material greatly deteriorates once it is soaked with liquid, when it is used in a humid environment, or when used repeatedly.

Generally, an un-punctured paper bag is highly resistant to tears due to various types of tear resistant barriers designed into the bag. However, once a puncture or cut exist on the paper bag, the paper bag is highly susceptible to tears, hence enlargement of the puncture or cut. It is often the case that once a layer of a paper bag is punctured by a foreign object, such as by an object stored in the bag, the weight of the foreign object tends to travel downward due to gravitational pull. As the foreign object travels downward beginning from the point of penetration of the paper bag, the initially small opening is enlarged because the amount of gravitational pull is greater than the tear tolerate point of the paper. As the opening is enlarged, objects stored therein the bag would fall out of the paper bag due to gravitational pull. Therefore, the paper bag is rendered useless.

Foldable bags made of plastic materials tend to be very resistant to deterioration when exposed to liquid or moisture. However, plastic provides a less rigidity characteristic than paper. A paper bag can maintain its form and rigidity even used under higher load than it is designed to withstand. Upon removal of the load, it is better able to return to its original shape and condition. Overall, a paper bag when used in dry conditions and used under loads slightly higher than it is designed to withstand would not be permanently damaged.

On the other hand, a plastic bag demonstrates very little rigidity and when used under a load slightly more than it is designed to withstand, it would begin to deform. Once any deformation occurs in a plastic bag material, the deformation becomes permanent. Upon removal of an object asserting the load, deformed plastic materials do not return to their pre-deformed shapes and conditions.

Furthermore, since plastic has a more uniformed molecular structure than paper, once there is a small puncture or a cut in the plastic bag, it requires very little amount of force to rip a plastic sheet wide open.

Therefore, both paper bags and plastics bags have serious shortcomings in that they are incapable to resist tears once they are punctured or cut.

As most paper and plastic bags are designed for temporary use typically not more than a few times, as they are inherently not made for durability or reusability. However, long-term durability or reusability of bags or for any other applications can be realized by using more durable and reusable materials.

### OBJECT OF THE INVENTION

An objective of the present invention is to overcome the above-discussed shortcomings of conventional materials.

Another object of the present invention is to manufacture a new material by adding a web material to a base material such as a plastic material, a paper material a foil material, any other polymer material, etc.

A third object of the present invention is to manufacture bags that are able to withstand higher loads and higher stresses than conventional bags.

A fourth object of the present invention is to make bags that are more resistant to tears once they are penetrated or cut by an object.

A fifth object of the present invention is to manufacture bags using a new material unknown among conventional bag making materials.

A sixth object of the present invention is to provide a safety net on a bag so as to prevent objects from falling out of the bag even if the bag made of conventional materials is torn or punctured.

A seventh object of the present invention is to use a new material as a communication medium to convey seasons of the year, occasions the bag is suited for and sentiments associated with the use of the bag.

An eighth object of this invention is to provide an apparatus-type flatbed for producing a laminated sheeting with a web material and a base material. The new material may be cut, sewn or glued to be used as a raw material for different applications.

A ninth object of this invention is to provide a paper or polymer with a laminated sheeting, which is intended to be used on gifts in general as a wrapping material.

A tenth object of this invention is to provide an apparatus for carrying out a preferred technique for producing a new material.

An eleventh object of the invention is to provide a high quality binder, providing cohesion and adhesion, adhesive strength, thermal stability and a high degree of union in binding a new material to paper or any kind of polymers.

A twelfth object of the invention is to manufacture a new material that is far more durable than conventional materials for making bags, gift-wraps or wrapping materials in general. Thus, bags or gift-wraps made by this new material are far more durable than conventional materials for making bags, gift-wraps or wrapping materials.

A thirteenth object of the invention is to manufacture bags, gift-wraps or wrapping materials that are capable for durable and repeated usage.

Other objects of the present invention will become more apparent upon review of the explanations given hereinunder.

### DRAWINGS OF THE PRESENT INVENTION

FIG. 1 illustrates a plan view of a general layout of a new material to be configured into a bag.

FIG. 2 illustrates a top view of the new material upon being partially configured.

FIG. 3 illustrates a bottom view of the new material upon being partially configured into a closure on one end.

FIG. 4 illustrates a side view of the new material being partially configured into a bag and adding thereto a top rim reinforcement member so as to more evenly distribute the load throughout the bag.

FIG. 5 illustrates a perspective view of the new material being fully configured into a bag.

FIG. 6 illustrates a diagrammatic view of an apparatus that adheres a web material onto a base material to become a new material and a number of stations to further process the new material.

FIG. 7 illustrates a side view of a web material being adhered to a base material by an adhesive.

FIG. 8A illustrates another view of a web material being adhered to a base material by an adhesive.

FIG. 8B shows a schematic diagram of an apparatus adapted to produce a sheeting by adhering and laminating a web material to a base material.

FIGS. 8-11 illustrate several plan views of a number of new materials each having a web material adhered onto a base material.

FIGS. 12-14 illustrate several perspective views of a number of bags made with the new material where the web material serves as a safety net of the base material.

### DETAILED DESCRIPTION

A new material is manufactured by adhering a web material onto a base material. The web material provides structural support and reinforcement to the base material so that when the two materials are used in conjunction, tear resistance, load bearing capacity and resistance to deformation are all enhanced. Therefore, any applications made with this new material will be more durable and can be used repeatedly. The web material may be material formed by weaving, knitting, pressing, or felting natural or synthetic fibers; a net, a lace, an allover lace or tulle knitted of either polyester, nylon, rayon, lurex, metallic wire, yarn or a combination thereof. A base material, for example, may be a paper material, a foil material, a cardboard material, a plastic material and a material formed by weaving, knitting, pressing, or felting natural or synthetic fibers.

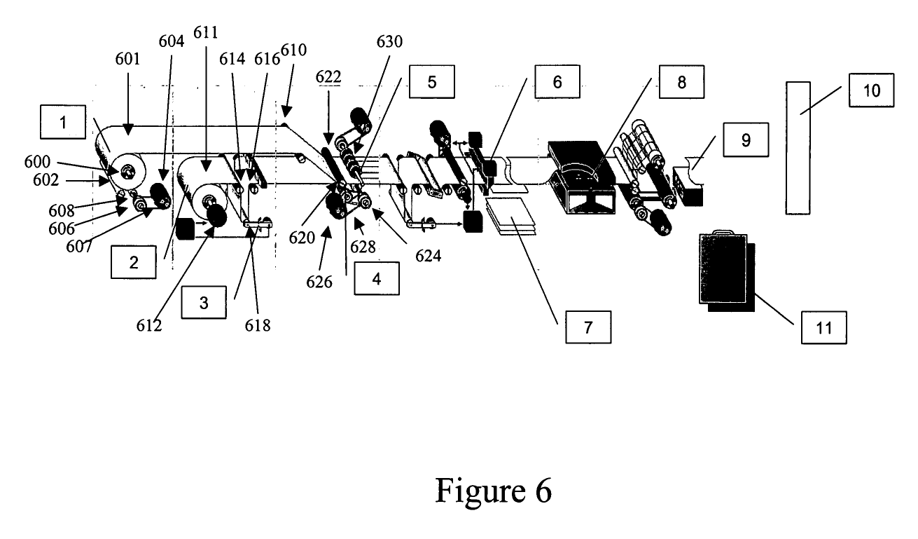

The manner in which the adhering of the web material and the base material, and post processing thereof is performed as shown by way of an example in a first embodiment in FIG. 6. As shown, there are 11 manufacturing stages divided into stations 1-11.

In station 1, a roll of a web material 601 is suitably installed onto a holding roller 600. The roll of web material 601 is biased between a stabilizing roller 602 and the holding roller 600 to minimize any other motions so as to ensure and isolate a rotating motion about the holding roller 600. The roll of web material 601 is also biased between the holding roller 600 and a driving roller 608 driven by a motor 604 via a driving shaft 606 and a driving belt 607. As the driving roller 608 frictionally rotates the roll of web material 601, the roll of web material is unwrapped and the unwrapped material travels toward a directing roller 610 in a bonding station 4.

In station 2, a roll of base material 611 is suitably installed onto a second holding roller 612. Any unwrapped based material 611 is guided by assisting rollers 614 and 616 to travel over an adhesive application roller 618 in an adhesive application station 3. Both the web material 601 and the base material 611 are fed between a second biasing roller 622, a second stabilizing roller 620 and a second driving roller 624. The second driving roller 624 is driven by a second motor 626 via a belt 628, in bonding station 4. As the web material 601 and the base material 611 traveled through the second biasing roller 622, the second stabilization roller 620 and the second driving roller 624, they are pressed by the rollers and held together by adhesives applied by the application roller 618. A new material is thus formed.

In slitter station 5, the new material is cut. Even though four cut rollers are shown to make up installation rollers 630, the number of actual rollers and the width of a roller may be altered depending upon specific needs.

Stations 6-11 are post-processing stations to cut and prepare the new material for specific applications. Station 6 is a sheeting cutting station. Station 7 is a sheet accumulating station. Station 8 is another bag cutting station. Station 9 is a cut sheet accumulating station. Station 10 is a new material based packaging station. Station 11 is a bag forming station.

Either of the roll of web material 601 or the base material 611 can be installed onto holding rollers 600 or 612, and vice versa. It all depends on whether adhesives are to be applied to the web material 601 or base material 611. In the illustrated example, the based material 611 is applied with adhesives. As the base material 611 is a long planar sheet of paper material, plastic material, foil material, etc., adhesives are applied onto the entire surface of the base material when coming in contact with the adhesive application roller 618. This would provide an advantageous effect in that a coating is being uniformly applied to the entire surface of the base material. This coating may produce a shade of sheen, a color scheme, an insulating layer, a reinforcement layer, a combination thereof, or other characteristics desirable for the application of the new material.

Alternatively, if the roll of web material 601 is installed onto the holding roller 612, adhesives will be applied only to the surface contact side of the web material formed by weaving, knitting, pressing, or felting natural or synthetic fibers, lace, tulle, allover lace, net, etc. This would provide an advantageous effect in that since a web material contains many devoids thus it would have much less contact surface area than a planar sheet of base material. Consequently, less adhesive is being used. Therefore, applying adhesives to the web material is an economical alternative to applying adhesives to the base material.

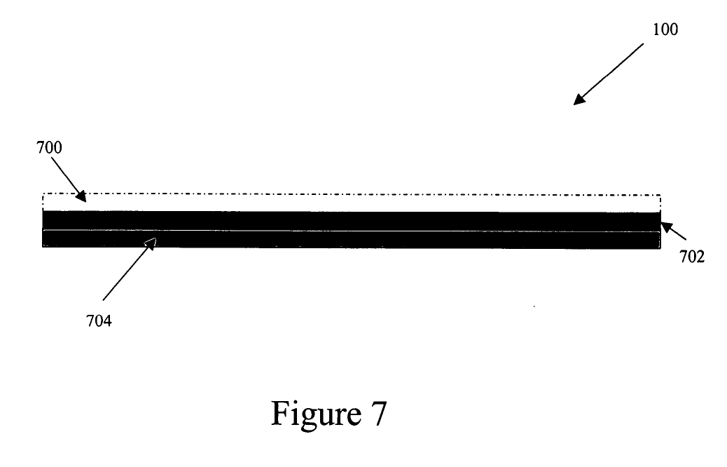

FIG. 7 illustrates a representative cross-sectional view of an adhesive 702 being sandwiched in-between web material 700 and base material 704. It should be noted that the thickness of the adhesive 702, web material 700 and base material 704 may not be the same. How much difference in thickness between these materials depends upon specific web material, base material and adhesive that are being used.

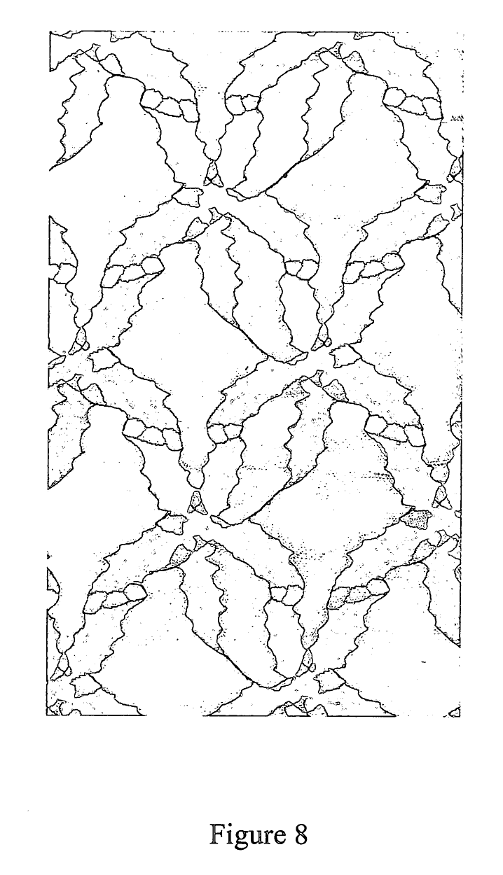

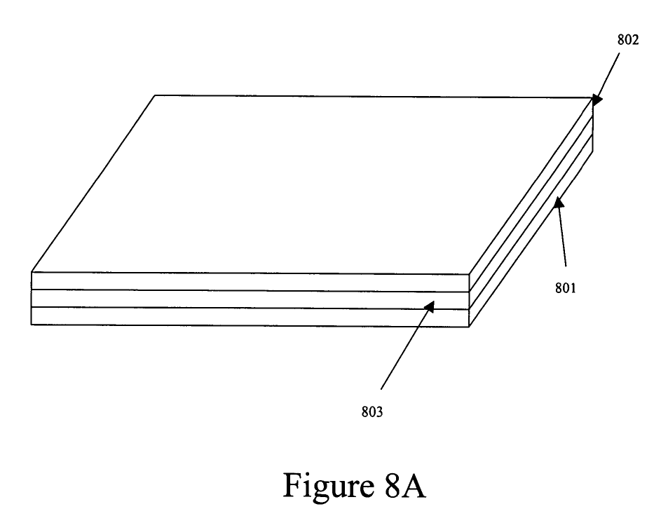

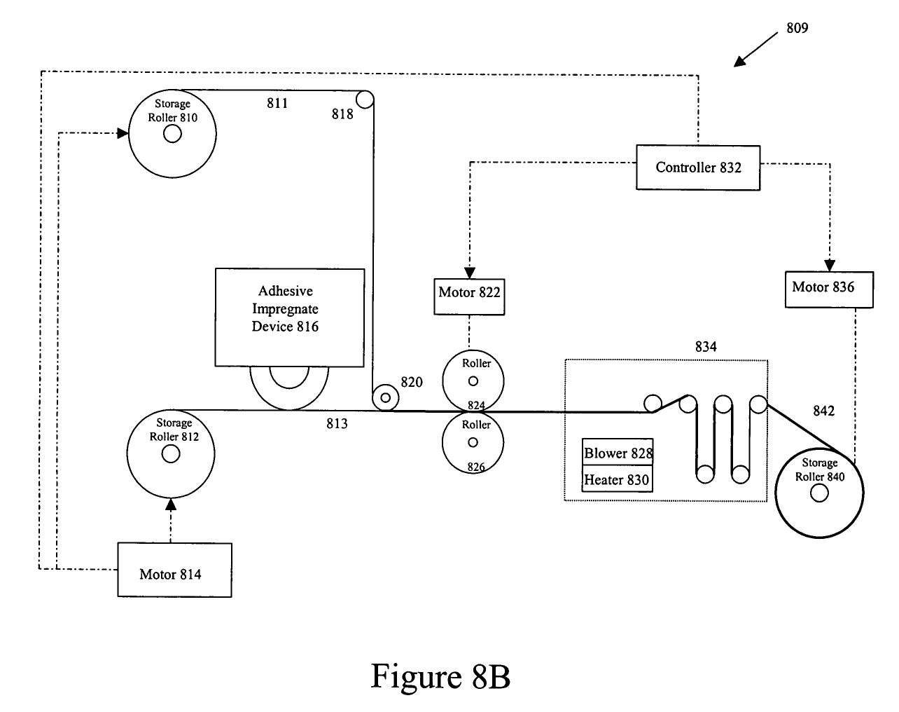

FIG. 8B discloses a diagrammatical view of a second embodiment of a lamination and binding machine 809 for making a new material. Input into the machine are two different materials pre-installed on a first storage roller 810 and a second storage roller 812. These materials can be either a base material or a web material. A web material, for example, may be material formed by weaving, knitting, pressing, or felting natural or synthetic fibers; a net, a lace, an allover lace or tulle knitted of either polyester, nylon, rayon, lurex, metallic wire, yarn or a combination thereof. A base material, for example, may be a paper material, a foil material, a cardboard material, a plastic material and a material formed by weaving, knitting, pressing, or felting natural or synthetic fibers.

In this example, stored thereon the first storage roller 812 is a web material 813, whereas stored thereon the second storage roller 810 is a base material 811. The decision to place either a web material 813 or a base material 811 onto one of the second storage roller 810 and the first storage roller 812 depends on which material should any adhesive be applied on. If any adhesive needs to be applied to the base material 811, the web material 813 can be stored on the second storage roller 810 and the base material 811 can be stored on the first storage roller 812. This would provide an advantageous effect in that a coating is being uniformly applied to the entire surface of the base material 811. This coating may produce a shade of sheen, a color scheme, an insulating layer, a reinforcement layer, a combination thereof, or other characteristics desirable for the application of the new material.

On the other hand, if any adhesive needs to be applied to the web material 813, the web material 813 can be stored on the first storage roller 812 and the base material 811 can be stored on the second storage roller 810. This would provide an advantageous effect in that since a web material contains many devoids thus it would have much less contact surface area than a planar sheet of base material. Consequently, less adhesive is being used. Therefore, applying adhesives to the web material 813 is an economical alternative of applying adhesives to the base material 811.

Output from the machine 809 is a new material 842 stored thereon a third storage roller 840.

Machine 809 is controlled by a controller 832, which in turn controls motor 814, motor 822 and motor 836, among other operations associated with this apparatus. Motor 814 controls the feeding of the base material 811 and web material 813. Motor 822 controls a pair of laminating rollers 824 and 826. Motor 836 controls the third storage roller 840. As the web material 813 and base material 811 are fed or released, to maintain a certain amount of tightness on the base material 811 and to channel the feeding direction of the base material 811, idler rollers 818 and 820 are present. As the web material 813 virtually travels on a linear path and the distance of travel is relatively short before reaching the adhesive impregnate device 816, no idler and redirecting rollers are needed. Adhesive 803 is uniformly applied on the web material 813. When the adhesive added web material 813 and the based material 811 meet at roller 820, the adhesive 803 is sandwiched in-between the web material 813 and base material 811. A pair of rollers 824 and 826 would then perform cold lamination by performing a crimping action on the web material 813, the adhesive 803 and the base material 811 toward each other to manufacture a new material 842. The combined behavior characteristics of the new material are distinctly different from either the characteristics of web material 813, the adhesive 813 and the base material individually. To facilitate further drying of the adhesive 803 after the performance of cold lamination, the new material 842 is fed through a drying unit 834 where a heater 830 generates heat, for example, in a range between 40 degrees to 60 degrees Celsius and a blower 828 circulates the heat within the drying unit 834. As the new material 842 circulated in the drying unit, for example, under the drying temperature for 8-10 seconds, is sufficiently dried, they are stored onto a storage roller 840.

The speed of the whole machine 809 will depend on the length of the drying unit 834 and the time of exposure needed to dry the materials at the designated temperature. For example, if the drying unit has a length of 5 meters and the time needed for the new material to be exposed to heat in the drying unit is 10 seconds, then the whole unit 809 will be performing at a speed of 30 meters per minute.

Cold lamination is effected at ambient temperature by a water-based adhesive, such as polyacrylic co-polymer composition. A preferred water-based adhesive is a polyvinyl acetate modified co-polymer, which is quick setting. This adhesive has an affinity for paper, polymer and other materials. Therefore, this adhesive would be suitable for many different types of base and web materials.

Because the water-based adhesive is fluid at ambient temperature, and is not a hot melt adhesive, no heat is applied to any web material or the base material, or any at least bi-axially oriented material as they are being laminated together. It is important to note that many web and base materials are heat sensitive, and at elevated temperatures, they tend to relax and lose their molecular orientation and tensile strength. Cold lamination at ambient temperature is, therefore, essential to produce a new material with high tear and burst strength. Therefore, hot lamination of the web material 813 and the base material 811 would provide an end product with an inferior result.

It also should be noted that a synthetic plastic material, such as polypropylene, is normally not receptive to adhesives, especially water-based adhesives. Hence, if one were to apply to the surface of this synthetic plastic material a water-based adhesive that is flowable at ambient temperature or at a temperature somewhat above ambient, but not at the elevated temperature of a hot melt adhesive, this water-based adhesive will not be absorbed by the synthetic plastic material.

Essential to the invention is that an adhesive polymer emulsion of excellent adhesion and mechanical properties, a poly (vinyl alcohol PVOH) stabilized vinyl acetate-ethylene emulsion needs to be used with a polymer.

New materials successfully made by adhering web materials with base materials are shown by way of examples in FIGS. 8, 9, 10 and 11. As shown in FIG. 8, a green, white and red web material is adhered to a white base material. This overall color scheme and pattern configuration is communicative of the Christmas season. Thus a bag made of this new material can be fashionably used during the Christmas season.

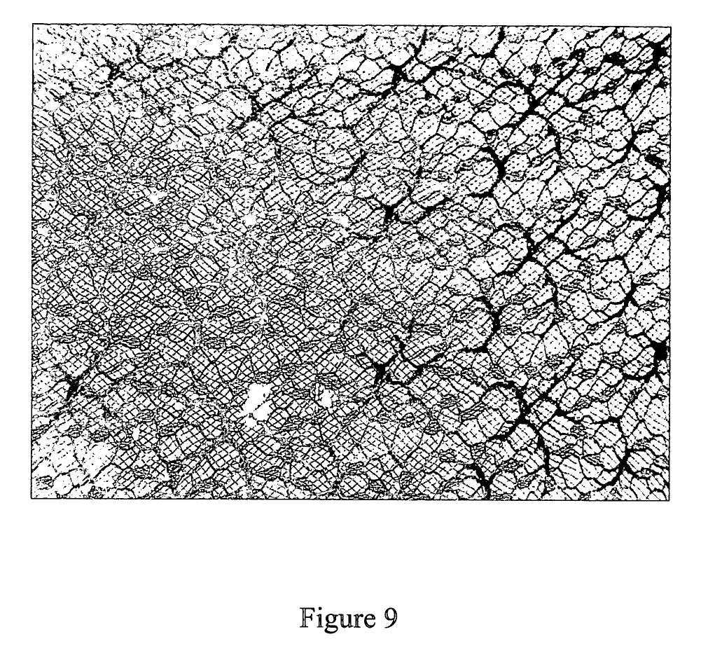

FIG. 9 is shown a brown and rice color web material being adhered to a pink base material. As pink is typically associated as a feminine color, this new material is communicative that the user of a bag made of this new material is either a female or the content stored therein the bag is designated for a female recipient.

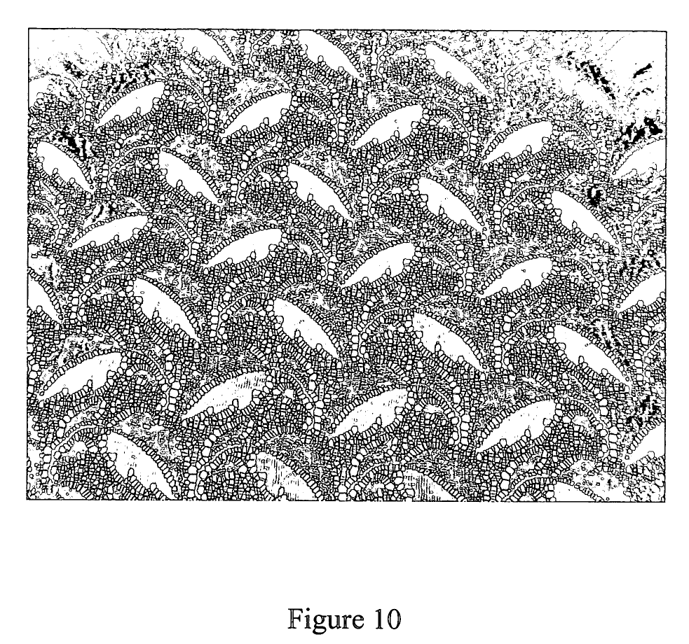

FIG. 10 is shown a blue web-material with leave and web patterns being adhered onto a white base material. Given that web material with leaves are preferred by females yet blue is a generally a masculine associated color, this color scheme and web pattern communicates that this new material may be used by either gender.

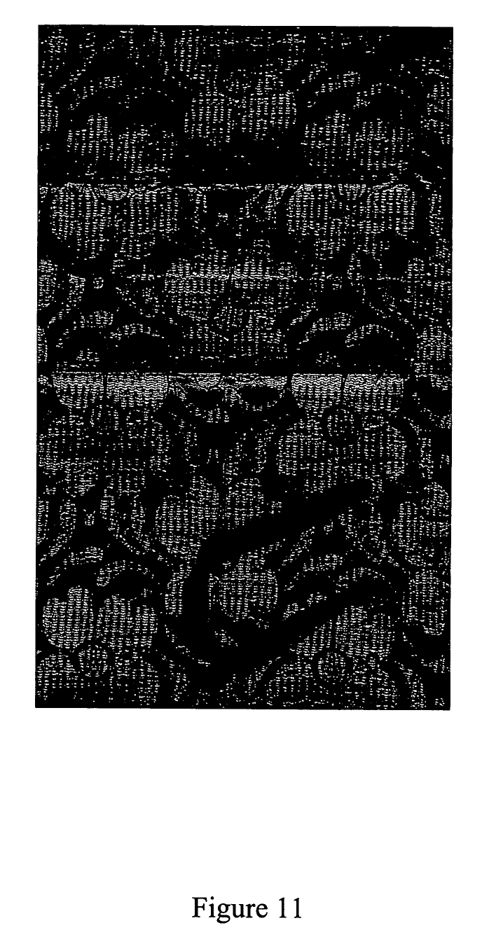

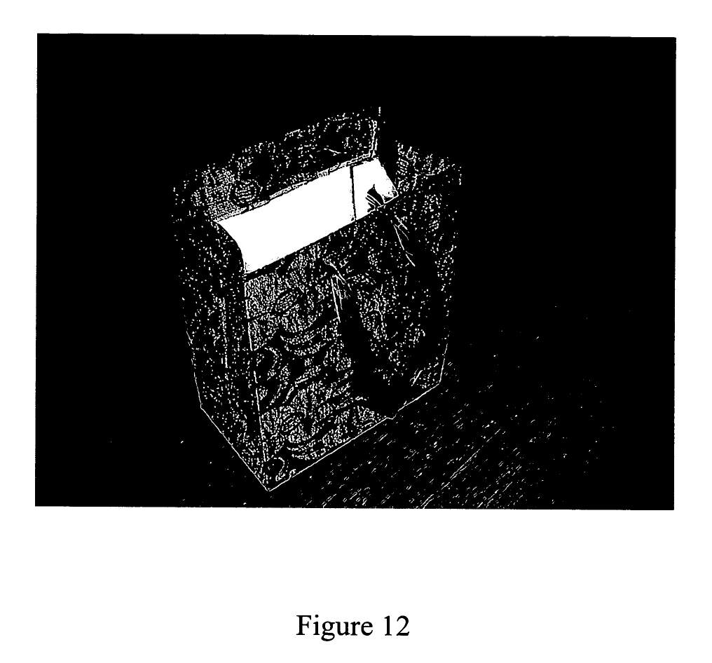

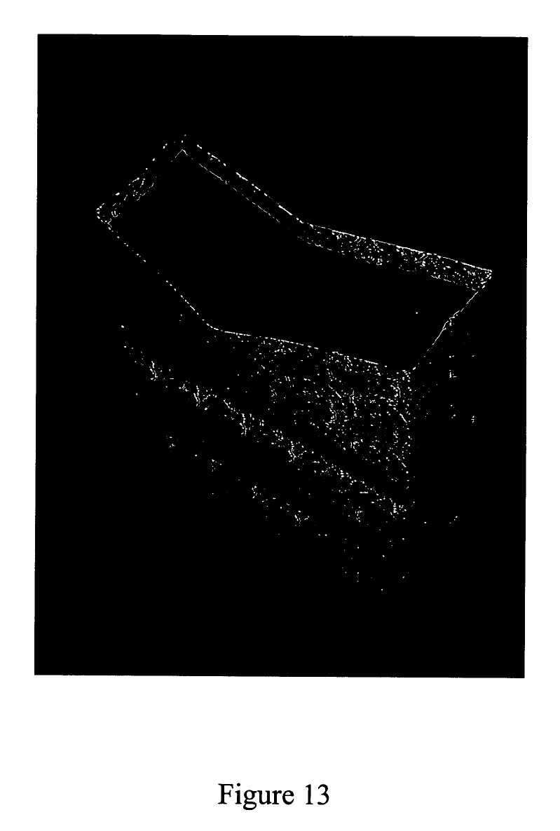

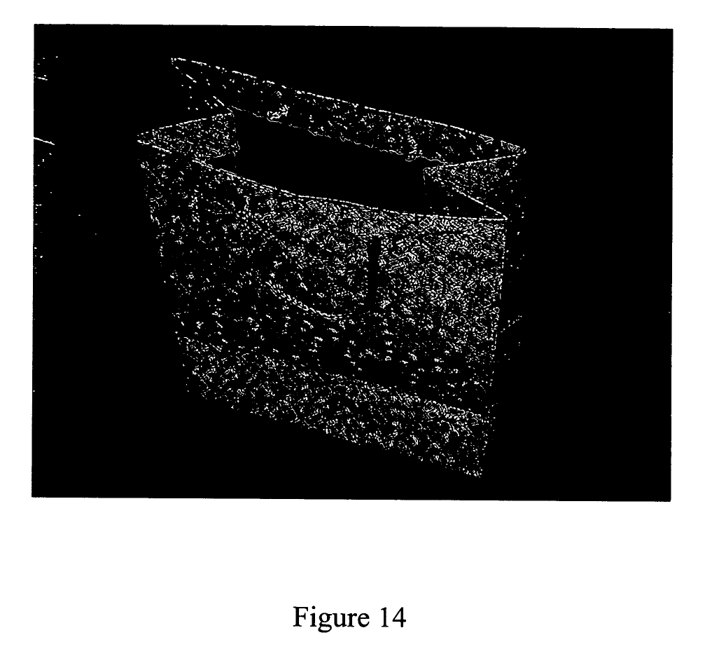

FIG. 11 is shown a white floral web material being adhered onto a deep maroon base material. As both the floral arrangement and the deep maroon color are more preferred by females, the use of this material would be communicative that any contents encompassed therein would be designated for a female recipient.

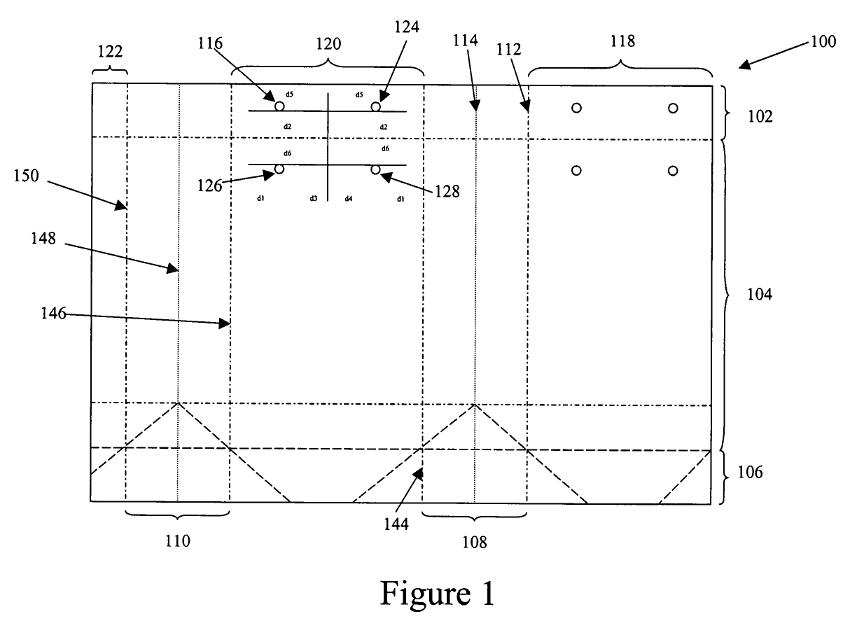

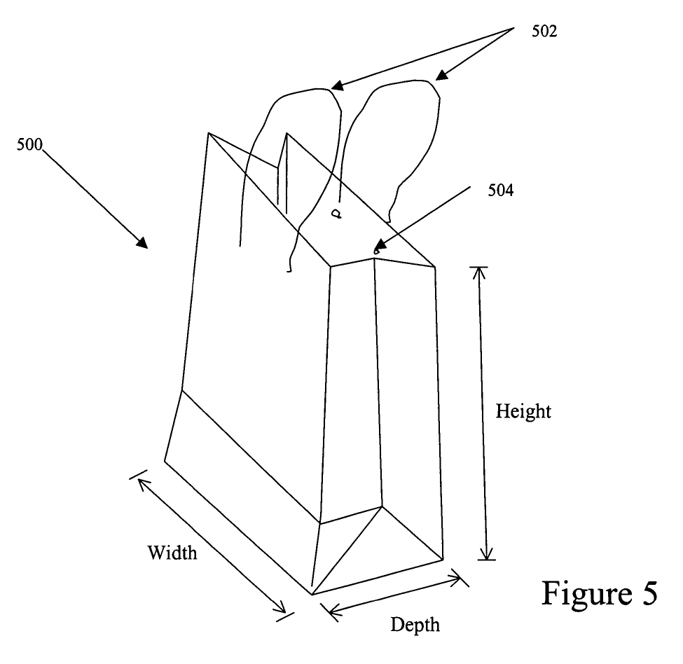

To make a foldable bag 500 as that shown in FIG. 5, the process starts from establishing a pattern on a piece of material as shown by way of an example in FIG. 1. As clearly shown, there are three different types of dash-lines, one type is composed of only a series of dots 114, another type is composed of a series of dashes and dots 112 and yet another type is composed of a series of long dashes 113. These three types of dash-lines signify a difference in folding directions. If a series of dots of dash lines signifies that portions parallel to the dash lines are to be folded into the paper of FIG. 1, then the series of dash lines and dots signifies that portions parallel to the dash lines and dots are to be folded out of the paper of FIG. 1. For our example, dash line 114 signifies folding both portions parallel to the dash line into the paper FIG. 1 and dash line 112 signifies folding both portions parallel to the dash line out of the paper of FIG. 1.

The series of long dash lines signifies that due to multiple layers of folding, portions parallel to this series of long dash lines may fold either into or out of the paper FIG. 1.

The numerous dash lines nicely divide the rectangular shape new material 100 into different zones. As shown, there are a header zone 102, a body zone 104, a footer zone 106, a first flat-side zone 118, a second flat-side zone 120, a first folding zone 108, a second folding zone 110, and a tap zone 122.

Located on each of the first flat-side zone 118 and the second flat-side zone 120 are four string holes 116, 124, 126 and 128. String holes 116 and 124 are complementary pairs of string holes 126 and 128, whereupon the folding of the header zone 102 to be flush with the body zone 104, holes 116 and 124 on the header zone 102 would correspondingly meet holes 126 and 128 on the body zone 104.

Exact and predetermined placement of string-holes 116, 124, 126 and 128 contributes to the overall durability of the bag under different usage conditions. For the horizontal placement of these holes, in a situation where the load is of the same foot print as that of the bag, thus the load placed on the bag 500 can be uniformly shared across the full width of the bag, then placement of these holes should observe the characteristics of d3=d4=d1.

In a situation where the load is not of the same foot print as that of the bag and the load tends to concentrate in the mid-width portion of the bag, then placement of these holes should observe the characteristics d3<d1, d4<d1 and d3=d4.

In a situation where the load is not of the same foot print as that of the bag and the load tends to concentrate on one side of the bag, then placement of these holes should observe the characteristics d1<d3, d1<d4 and d3=d4.

These string-holes may be individually created on the header zone and the body zone. They can also be created after the header zone is folded into the body zone. They can further be created after a reinforcement member 400 is adhered in-between the header zone and the body zone.

As bags are manufactured in different sizes; generally, the larger is the size of the bag, the more important it is to correctly choose the placement of the string-holes. However, depending on the size and weight of the load, these horizontal string-hole placement considerations are also applicable to smaller size bags.

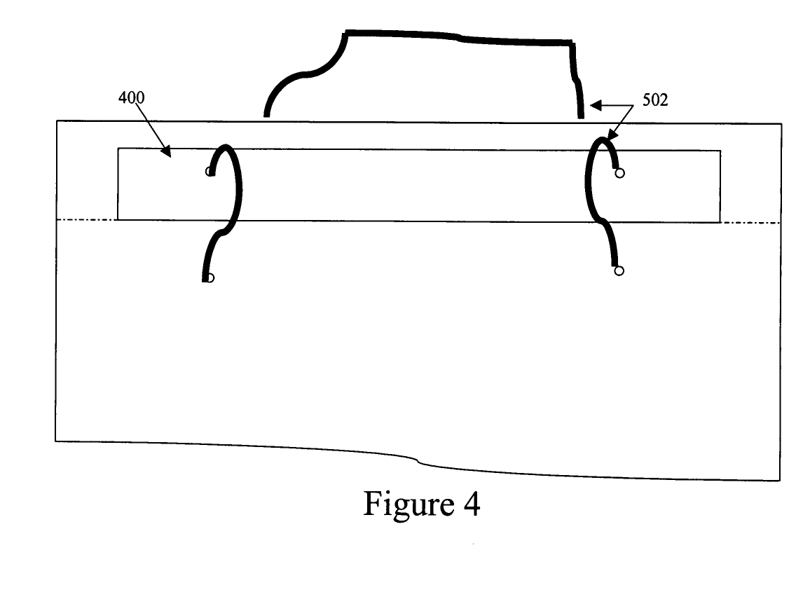

Vertical placement of string-holes 116, 124, 126 and 128 should observe characteristics that d2=d6 and d2>d5. This is to compensate for the fact that while the material at the rim of these holes experience the most amount of compressive force, the edge of the material above these holes experience the most amount of tensile force, due to the load. In addition to the concerns over the placement of the ring-holes, a reinforcement member 400 should also be added in-between the header zone 102 and the body zone 104. This reinforcement member helps regions surrounding string-holes 116, 124, 126 and 128 to withstand the compressive force and tensile force so as to prevent material 100 from breaking down and cause a tear to occur beginning from around the rims of the string-holes. An eyelet may also be added to each string-hole as a further tear prevention device. This reinforcement member 400 also helps to redistribute the load evenly across the width of the bag. To redistribute the load across the full width of the bag, the width of the reinforcement member 400 should be the full width of the bag. However, as shown in FIG. 4, the reinforcement member 400 is shown by way of an example to be shorter than the full width of the bag. The bag shown in FIG. 4 thus has a lighter load capacity than a bag where the reinforcement member is the full width of the bag.

It is preferred that the reinforcement member 400 be adhered in-between the header zone 102 and the body zone 104, this would further ensure that all surfaces coming into contact with the reinforcement member 400 evenly share the load and evenly distribute sharing of the load to other zones of the bag.

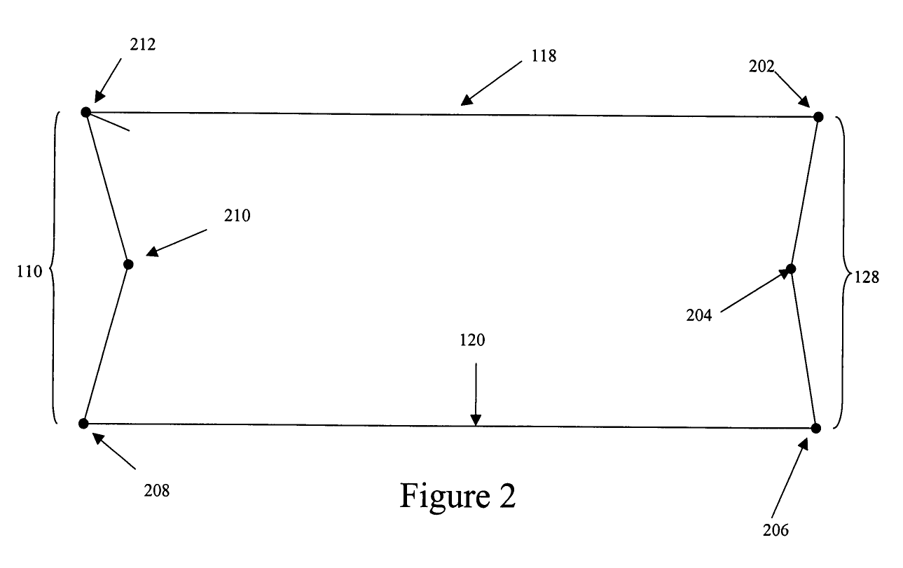

FIG. 2 illustrates a bottom view of material 100 that is being folded along various fold lines. Points 202, 204, 206, 208, 210 and 212 respectively correspond to fold lines 112, 114, 144, 146, 148 and 150. An outer surface of the tap 122 is adhered to an inner surface of the first flat-side zone 118. The larger is the size of the tap 122, the more surface contact will there be between the tap 122 and the first flat-side zone 118. The stronger will also be the integrity of the bag. Given that the new material 100 has a web side, the devoid spaces formed by the web patterns effectively create an adhesive retaining pool, so that greater amount of adhesives may be used to provide a stronger hold of two contacting surfaces. This retaining pool feature also contributes to the making of a stronger bag.

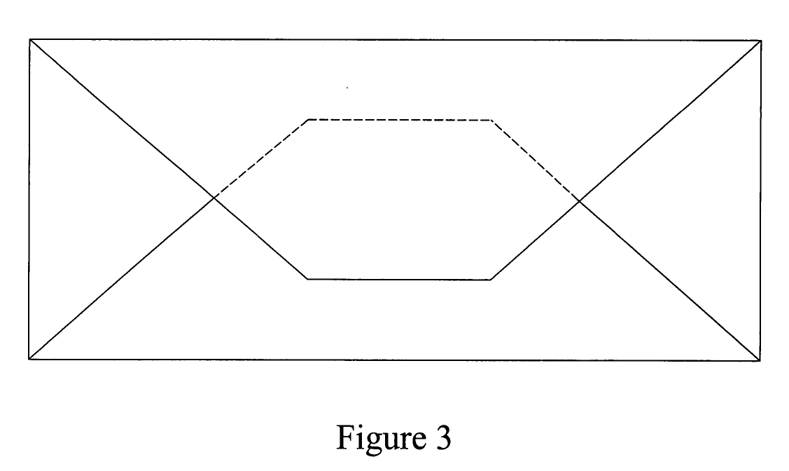

FIG. 3 provides another bottom view showing the footer zone being folded along various long dash lines to form a closure end. Specifically, the closure end is made by folding a first bottom edge of the first folding zone 110 and a second bottom edge of the second folding zone 108 toward each other so that the first and second bottom edges are substantially parallel. Then there is further folding of a third bottom edge of the first flat-side zone 118 and a fourth bottom edge of the second flat-side zone 120 toward each other to form a first closure tab and a second closure tab in a way that the third and fourth bottom edges are substantially parallel and overlapping each other. The closure end is finalized by adhering the first closure tab to the second closure tab wherein the web material on one of the first closure tab and the second closure tab form a retaining wall to retain a pool of adhesives when the first closure tab is adhered to the second closure tab at the overlapping surfaces.

Again, due to the presence of web patterns to retain a greater amount of adhesive material, the closure end of the present invention is much stronger than conventional closure ends without the benefit of the retaining wall to retain a pool of adhesives.

There is a supporting plate member (not shown) placed on the bottom of the bag yet residing above the closure end. This supporting plate member is of substantially the same size as the bottom of the bag. It provides further rigidity and load bearing capacity to the bottom of the bag.

From the foregoing detailed description, it will be evident that there are a number of changes, adaptations and modifications of the present invention that come within the province of those persons having ordinary skill in the art to which the aforementioned invention pertains. However, it is intended that all such variations not departing from the spirit of the invention be considered as within the scope thereof as limited solely by the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. An apparatus for manufacturing a new material through cold lamination and adhesion, comprising:
a roll of continuous web material pre-stored on a first roller is motivated by a first motor, one end of the continuous web material is attached to a third roller motivated by a third motor;
a roll of continuous base material pre-stored on a second roller is motivated by a second motor; one end of the continuous base material is attached to the third roller motivated by the third motor;
an adhesive impregnate device applied a coat of adhesive at a room temperature to the continuous web material as it travels from the first roller toward the third roller;
a first idler roller channels the continuous base material to be overlaid on top of the continuous web material with the coat of adhesive situated thereinbetween; and
a pair of pressing rollers motivated by a fourth motor rotatably compressed the continuous web material, the coat of adhesive and the continuous base material toward each other at a predetermined compressive force to manufacture the new material;
wherein a controller provides synchronous control to the first motor, the second motor, the third motor and the fourth motor.

14. An apparatus for manufacturing a new material through cold lamination and adhesion, comprising:
a roll of continuous base material pre-stored on a first roller is motivated by a first motor, one end of the continuous base material is attached to a third roller motivated by a third motor;
a roll of continuous web material pre-stored on a second roller is motivated by a second motor; one end of the continuous web material is attached to the third roller motivated by the third motor;
an adhesive impregnate device applied a coat of adhesive at a room temperature to the continuous base material as it travels from the first roller toward the third roller;
a first idler roller channels the continuous web material to be overlaid on top of the continuous base material with the coat of adhesive situated thereinbetween; and
a pair of pressing rollers motivated by a fourth motor rotatably compressed the continuous web material, the coat of adhesive and the continuous base material toward each other at a predetermined compressive force to manufacture the new material;
wherein a controller provides synchronous control to the first motor, the second motor, the third motor and the fourth motor.

15. The apparatus for manufacturing the new material of either claim 13 or claim 14, wherein the predetermined compressive force is substantially at 8.8 lbs/in².

16. The apparatus for manufacturing the new material of either claim 13 or claim 14, wherein the new material undergoes the drying process for a period between eight to ten seconds.

17. The apparatus for manufacturing the new material of either claim 13 or claim 14, wherein the new material undergoes a drying process in a drying chamber supplied with heat at a predetermined temperature from a heater and a blower circulating the heat to consolidate material characteristics of the new material.

18. The apparatus for manufacturing the new material of either claim 13 or claim 14, wherein the predetermined temperature is in a range between 40° C. and 60° C.

19. The apparatus for manufacturing the new material of claim 18, wherein the drying chamber comprises a plurality of rollers creating a number of meandering paths for the new material to travel through so as to maximize the amount of surfaces of the new material to undergo the drying process within the drying chamber.

20. The apparatus for manufacturing the new material of either claim 13 or claim 14, wherein the web material is one of an at least bi-axially oriented material, a material formed by weaving, knitting, pressing, or felting natural or synthetic fibers, a net, a lace, a tulle, an allover lace made of one of polyester, nylon, rayon, lurex and cotton.

21. The apparatus for manufacturing the new material of either claim 13 or claim 14, wherein the base material is one of an at least bi-axially oriented material, a paper material, a foil material, a cardboard material, a plastic material and a material formed by weaving, knitting, pressing, or felting natural or synthetic fibers.

22. The apparatus for manufacturing the new material of either claim 13 or claim 14, wherein the adhesive material is a water-based adhesive.

23. The apparatus for manufacturing the new material of either claim 13 or claim 14, wherein the adhesive material comprises a polyvinyl acetate modified co-polymer.

24. The apparatus for manufacturing the new material of either claim 13 or claim 14, wherein the adhesive material comprises a poly (vinyl alcohol PVOH) stabilized vinyl acetate-ethylene emulsion.

25. The apparatus of manufacturing the new material of either claim 13 or claim 14, wherein a predetermined speed of feeding of the continuous web material and the continuous base material will depend on a length of the drying unit and the time of heat exposure needed to dry the materials at the designated temperature.

26. (canceled)

27. (canceled)

28. (canceled)

29. (canceled)

30. (canceled)

31. (canceled)

32. (canceled)

33. (canceled)

34. (canceled)
